(19) United States
(12) Patent Application Publication
(10) Pub. No.: US 2025/0136505 A1
(43) Pub. Date: May 1, 2025

(54) CALCIUM ALUMINATE PHOSPHATE CEMENTS

(71) Applicants: Mark L. F. Phillips, Albuquerque, NM (US); National Technology & Engineering Solutions of Sandia, LLC, Albuquerque, NM (US)

(72) Inventors: Mark J. Rigali, Albuquerque, NM (US); Mark L. F. Phillips, Albuquerque, NM (US)

(21) Appl. No.: 18/932,186

(22) Filed: Oct. 30, 2024

Related U.S. Application Data
(60) Provisional application No. 63/594,563, filed on Oct. 31, 2023.

(51) Int. Cl. C04B 12/02; C04B 40/00

(52) U.S. Cl. CPC C04B 12/025; C04B 40/0082

(57) ABSTRACT

Calcium aluminate phosphate cements (CAPCs) are compositions comprising calcium aluminum oxides, phosphates, and water. These cements demonstrate considerable compressive strength and dissolution resistance and may serve as replacements for ordinary Portland cements (OPCs). They offer the added benefit of a low carbon footprint as compared to OPCs.

### CROSS-REFERENCE TO RELATED APPLICATION

This application claims priority to U.S. Provisional Application No. 63/594,563, entitled “Calcium Aluminophosphate Cements,” filed Oct. 31, 2023, by Rigali et al., and U.S. Provisional Patent Application No. 63/475,923, entitled “Calcium Aluminophosphate Cements,” filed Dec. 24, 2022 by Phillips et al. and PCT Application No. PCT/US2023/085929, entitled “Calcium Aluminophosphate Cements,” filed Dec. 26, 2023, by Phillips et al., the entireties of which are hereby incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD

The present disclosure is generally directed to cements, and more specifically directed to calcium phosphate cements whose manufacture produces less CO₂ emissions than Portland cement.

### BACKGROUND

Commercial generation of energy by nuclear power plants in the United States (U.S.) has produced thousands of metric tons of spent nuclear fuel (SNF), the disposal of which is the responsibility of the U.S. Department of Energy (DOE). Utilities typically utilize the practice of storing this SNF in dual-purpose canisters (DPCs). DPCs were designed, licensed, and loaded to meet Nuclear Regulatory Commission (NRC) requirements that preclude the possibility of a criticality event during SNF storage and transport, but were not designed or loaded to preclude the possibility of a criticality event during the regulated post-closure period following disposal, which could be up to 1,000,000 years.

There are several options being investigated that could facilitate the disposal of SNF stored in DPCs in a geologic repository. These include: (1) repackage the SNF into canisters that are designed to prevent criticality during the regulated post-closure period following disposal, but with an increased disposal cost estimated at approximately $20B in U.S. dollars; (2) analysis of the probability and consequences of criticality from the direct disposal of DPCs during a 1,000,000-year post-closure period in several geologic disposal media; and (3) filling the void space of a DPC with a material before its disposal that significantly limits the potential for criticality over the post-closure regulatory period.

Additionally, many applications that use cements as barriers and/or structural materials would benefit from using reduced carbon footprint cements that have low environmental impact. At this time, there are no cements that overcome the deficiencies and limitations of known cements.

What is needed are cements that have considerable compressive strength and dissolution resistance and a reduced carbon footprint that can serve as replacements for ordinary Portland cements (OPCs).

### SUMMARY OF THE INVENTION

The present disclosure is directed to calcium aluminate phosphate cements (CAPCs). CAPCs may also be referred to as calcium aluminophosphate cements or calcium aluminum phosphate cements.

The present disclosure is further directed to a composition that includes a source of calcium and aluminum that is calcium aluminate and a source of phosphate to form a calcium aluminate phosphate cement (CAPC).

The present disclosure is also further directed to an article formed of a source of calcium and aluminum that is a calcium aluminate and a source of phosphate to form a calcium aluminate phosphate cement (CAPC).

The present disclosure is also further directed to a method of making a cement that includes mixing a source of calcium and aluminum that is a calcium aluminate with a solution comprising water and a phosphate source to form a slurry; forming the slurry into a pre-article; and curing the pre-article into an article to form a cementaceous body.

An advantage of the disclosed cements is that they possess considerable compressive strength and dissolution resistance and may serve as replacements for ordinary Portland cements (OPCs).

Another advantage of the disclosed cements is that they offer a low carbon footprint as compared to OPCs.

Further advantages of the disclosed cements include: resistance to high temperature (at least 800° C.) after cure, net shape curing, ingredients are non-hazardous and environmentally benign, curing that can be accelerated by heat, corrosion resistance, low to moderate viscosity, near-neutral pH, composed of earth-abundant ingredients. The cured cements can also immobilize various radionuclides and may thus be useful in radioactive waste disposal applications.

### BRIEF DESCRIPTION OF THE DRAWINGS

FIG. 1 is a photo of CaAl₄O₇/(NaPO₃)₆ cement piece from Example 1 according to an embodiment of the invention.

FIG. 2 is a photo of CaAl₄O₇/H₃PO₄/(NaPO₃)₆ cement from Example 3 after 150° C. cure according to an embodiment of the disclosure.

FIG. 3 is a photo of cement made from CaAl₄O₇ and 10-34-0 (Example 4) after cure according to an embodiment of the disclosure.

FIG. 4 is a photo of cured cement from Example 5 according to an embodiment of the disclosure.

FIG. 5 is a photo of cement made in Example 6 according to an embodiment of the disclosure.

FIG. 6 is a photo of cured cement from Example 7 according to an embodiment of the disclosure.

FIG. 7 is a photo of cement from Example 8 according to an embodiment of the disclosure.

FIG. 8 is photo of cement made in example 15 according to an embodiment of the disclosure.

FIG. 9 is a photo of glass cement monolith made in Example 17 according to an embodiment of the disclosure.

FIG. 10 is a photo of fly ash phosphate cement made in Example 18 according to an embodiment of the disclosure.

### DETAILED DESCRIPTION OF THE INVENTION

The present disclosure is directed to calcium aluminate phosphate cements (CAPCs). The source of Ca is calcium oxide chemically bonded in a crystalline or amorphous phase containing aluminum oxide; this phase or phases may also comprise one or more of the oxides of aluminum, silicon, and boron. The source of phosphate contains orthophosphate, metaphosphate, or polyphosphate in combination with sodium, potassium, ammonium, and/or calcium.

In an embodiment, the CAPC is formed by combining a source of calcium and aluminum that is a calcium aluminate with a source of phosphate. In an embodiment, the calcium aluminate may be CaAl₄O₇ (CA2, the mineral grossite nomenclature used in the cement industry), hibonite CaAl₁₁O₁₉ (CA6, the mineral hibonite nomenclature used in the cement industry), and CaAl₂O₄ (CA, the mineral krotite). CA2, CA6, CA, and C3A are cement chemist's shorthand for the formulas CaAl₄O₇, CaAl₂O₁₉, CaAl₂O₄, and Ca₃Al₂O₆, respectively.

The binder phase that is formed by the reaction or curing of the calcium aluminate and source of phosphate is an amorphous or cryptocrystalline material comprising Ca, P, O, and H. Any other elements present in the Ca source or the phosphate source may also be present in the binder phase.

The source of phosphate for calcium aluminophosphate cements may be selected from any phosphate donor that releases phosphate in solution to react with a source of calcium. In some embodiments, these include alkali orthophosphates, metaphosphates, polyphosphates, and phosphates in combination with other elements such as calcium, BPO₄, phytate, and basic oxygen slag. In an embodiment, the polyphosphate may be sodium tripolyphosphate, Na₅P₃O₁₀. The phosphate may also be a component of waste products such as incinerated sewage sludge. In an

In an embodiment, the source of phosphate may be a metaphosphate such HPO₃, NaPO₃, KPO₃, NH₄PO₃, (NaPO₃)₆ and (NaPO₃)₃ alone or in combination. In an embodiment, the source of phosphate may be an alkali orthophosphate, such as but not limited to NaH₂PO₄, Na₂HPO₄, Na₃PO₄, KH₂PO₄, K₂HPO₄, K₃PO₄, NH₄H₂PO₄, (NH₄)₂HPO₄, alone or in combination. In an embodiment, the source of phosphate may be orthophosphoric acid also known as phosphoric acid H₃PO₄. It may be used alone or in combination with one or more alkali phosphates or polyphosphates. In an embodiment, the source of phosphate may be a polyphosphate such as, Na₅P₃O₁₀, or its potassium or ammonium derivatives, alone or in combination. In an embodiment, the source of phosphate may be boron phosphate BPO₄.

In an embodiment, the calcium phosphate may be Ca(H₂PO₄)₂ also known as superphosphate.

The mole ratio of calcium aluminate to total phosphate is between 0.5-10. In an embodiment, the mole ratio of calcium aluminate to total phosphate is between 1-2.

In other embodiments, the CAPC may include optional materials, such as but not limited to aggregate and surfactants. In other embodiments, the CAPC may include substitutional materials, such as but not limited to wollastonite (CaSiO₃), sand, gravel, limestone, granite, ground cullet, glass fiber, kaolin, metakaolin, coal ash and steel reinforcing material (rebar). In an embodiment, substitutional materials may replace up to 95% of the CAPC by volume.

In other embodiment, the CAPC may include optional materials, such as but not limited to viscosity reducers and/or retarders such as sodium lignosulfonate or sodium poly(naphthalene sulfonate). In an embodiment, optional materials may be up to 10% of the CAPC by volume.

The reactivity of the starting material disclosed above with phosphate follows the order CA6<CA2<CA<C3A. CA6 reacts slowly with mono-orthophosphates such as H₃PO₄ and NH₄H₂PO₄ and may require heating to produce a useful set time. CA2 and CA react with mono-orthophosphates to form cements that set at room temperature (20° C.) in minutes or hours. CA2 and CA react with metaphosphates, such as (NaPO₃)₆ and ammonium polyphosphate (a commercial fertilizer, commonly sold by its NPK designation 10-34-0) much more slowly and can remain fluid at 20° C. after a week or more before setting. C3A reacts immediately with mono-orthophosphates and rapidly (few minutes) with metaphosphates at standard temperature (25° C.) but can react slowly with solid-state phosphate sources such as triple superphosphate (approximately Ca(H₂PO₄)₂) or (NH₄)₂HPO₄ or K₃PO₄ or basic oxygen slag. C3A reacts at a slower rate at reduced temperatures (e.g., lower than 0° C.) and is thus effective in structural cements used in low-temperature environments.

The calcium aluminate used can be a pure phase, or a mixture of calcium aluminate phases, or a mixture of calcium aluminate with corundum. The latter is a common co-ingredient with calcium aluminates if the reaction that forms calcium aluminate from CaO and Al₂O₃ is off-stoichiometry or the formation of calcium aluminate does not go to completion. Unreacted corundum will react with H₃PO₄ and ortho-monophosphates to produce a cementitious phase at elevated temperatures (typically >100° C.). The presence of calcium aluminates in a cement containing corundum and phosphate can confer dimensional stability and strength to the cured concrete.

Calcium aluminate starting materials can also be combined with calcium silicates such as wollastonite, sintered clays such as metakaolin, other sources of calcium such as coal ash (boiler ash or fly ash), powdered glass such as soda lime silica, other crystalline Ca-containing phases such as anorthite, or calcium borates, and compounds containing rare-earth elements.

The CA and CA₂ calcium aluminates and CaSiO₃ (wollastonite) are very effective as cements in combination with phosphate because they react with phosphate at a similar rate. They can be blended from 100% CaSiO₃ to 100% Ca/Al/O. At high CaSiO₃ concentration the cement exhibits the dimensional stability imparted by the low settling rate of the CaSiO₃ compared with the CA or CA2. At low CaSiO₃ concentration, the cement benefits from the higher strength imparted by the calcium aluminate phosphate.

Rare-earth oxides of the formula Ln₂O₃ (Ln=La—Lu, Sc, or Y) are highly alkaline and react with acidic phosphates such as H₃PO₄ and ortho-monophosphates. They react more slowly with metaphosphates. Their reactivity compares with calcium aluminates thusly: CA6<CA2<CA<Ln₂O₃<C3A. They are useful for shortening the set time of calcium aluminates with less reactive phosphates such as metaphosphates, thereby promoting dimensional stability of the product, i.e., less shrinkage. In an embodiment, the range of Ln2O3 in the cement may be between 0-10 mole percent.

Binary rare-earth oxides are also effective in mixtures with calcium aluminates and are typically less reactive than Ln₂O₃ phases. These include rare-earth silicates, aluminates (such as LnAlO₃ perovskite phases), and borates. In general, the reactivity of a binary rare-earth oxide varies inversely with its mole fraction of Ln content. In an embodiment, the range of binary rare-earth oxides may be between 0-100 mole percent.

In some CAPCs, the setting of the cement is accompanied by the formation of a gel phase, termed a poorly crystalline calcium phosphate (or PCCP). This is especially notable in cements containing CaAl₄O₇ in combination with (NaPO₃)₆. This material (PCCP) is effective at sequestering metal ions, particularly alkaline earths (SrII), lead, Ra, U(VI as UO₂²⁺), and actinides, for example Pu(VI). The PCCP phase can crystallize to apatite (Ca₅(PO₄)₃X), where X is a monovalent anion such as hydroxide (OH⁻) or chloride (Cl⁻). This structure can also incorporate anions such as iodide (I⁻), iodate (IO₃⁻), pertechnetate (TcO₄⁻), and perchlorate (ClO₄⁻).

The phosphate cement can be used as a cement paste by itself or with an aggregate (sand and/or gravel). The aggregate will ideally contain a chemical element that reacts with phosphate such as calcium to promote bonding between the paste and the aggregate. This can be a calcium rich material such as limestone as well as less-reactive materials such as granite, which can contain Ca phases such as anorthite. The aggregate can also be a glass filler and/or glass mats composed of Ca-containing glass such as E-glass, to which the phosphate cement can bond. Bonding to reinforcing steel (rebar) also takes place.

The principal advantages of calcium aluminophosphate cements over other cements such as ordinary Portland cement (OPC) are higher strength, thermal resistance, lack of alkaline corrosivity, and less susceptibility to corrosion from environmental chloride and sulfate. They are also less toxic by inhalation. They also involve less CO₂ generation in production and can be made with a higher proportion of natural products. They can also capture CO₂ from ambient air.

The CAPCs may be used in many applications, such as but not limited to:
a. Construction materials for structures such as but not limited to nuclear reactors, buildings, sidewalks and dams;
b. Road and rail construction materials including patch materials for repair;
c. Passivation layers on OPC to impart chemical resistance to corrosives such as but not limited to road salt;
d. Fillers for nuclear waste disposal including storage and transportation canisters, dual purpose canisters (DPCs) and other radioactive waste disposal canisters and containers;
e. Construction material for radioactive waste disposal vaults at or near the earth's surface;
f. Construction material for deep borehole disposal;
g. Oil and geothermal well casings;
h. Reduced CO₂ free cement, CO₂ capture cement;
i. Grout, including but not limited to grout for nuclear waste encapsulation, e.g., of cesium, strontium, uranium iodine and technetium loaded resins and inorganic sorbents for example, crystalline silicotitanates (CSTs);
j. Lunar and other extraterrestrial concrete and construction materials: for example, Ca-containing lunar regolith will react with phosphate and water to form a structural cement; and
k. 3-D printable concrete using thixotropic additives, binders, or resins to enhance extrudability and reduce slump.

### Methods of Making Calcium Aluminate Phosphate Cements (CAPCs)

(CAPCs) are formed by reacting calcium aluminates with phosphate to produce cements. In an embodiment, the calcium aluminate is the highly alkaline and reactive Ca3Al2O6 “C3A” phase. When used with a reactive phosphate such as an orthophosphate, a cement forms and sets rapidly at room temperature.

A phosphate is added to water and mixed to form a solution or suspension. The solid phase or phases is then added with one or more sources of calcium that are chemically bonded to aluminum oxide, and/or silicon oxide and/or boron oxide.
Step 1: mixing calcium aluminate with a solution containing water and a source of phosphate to form a slurry;
Step 2: forming slurry into a shape; and
Step 3: These cements are set by allowing them to stand at ambient (e.g., room temperature). These formulations can set over a broad range of temperatures from 15° C. to 250° C. in the presence or absence of water. The cements tend to set faster as temperature is increased.

### EXAMPLES

### Example 1: CaAl₄O₇ with (NaPO₃)₆

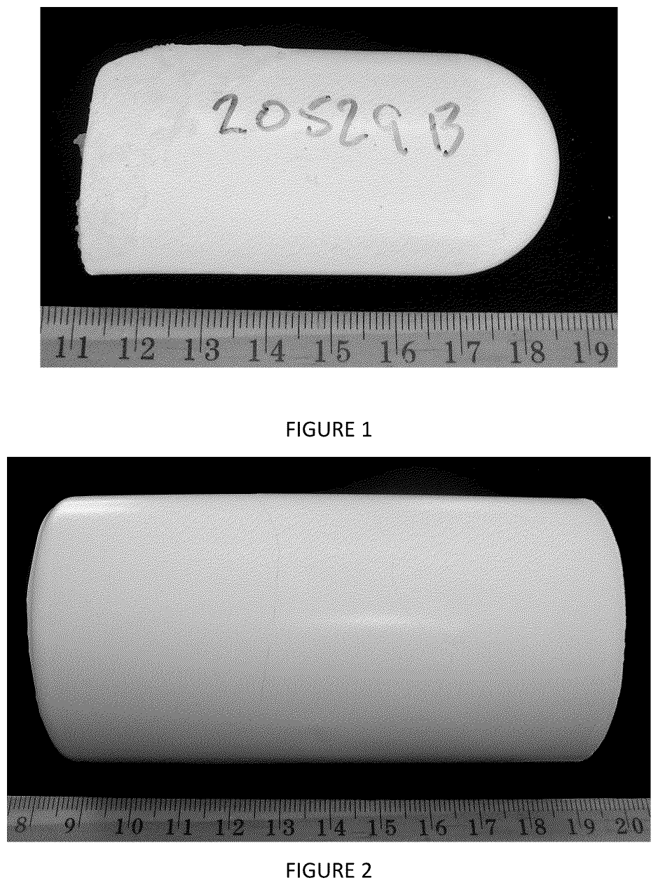

93.6 g CaAl₄O₇ was mixed with a solution containing 18.4 g (NaPO₃)₆ (sodium hexametaphosphate) in 37 g H₂O to form a slurry. The slurry was poured into a 100 mL centrifuge tube. After 8 hours (hr), it was placed in an oven at 85° C., which was then heated to 130° C. at 5° C./hr, then held at 130° C. for 8 hr. After cooling, the monolith was removed and heated at 250° C. for 12 hr (see FIG. 1). In an embodiment, the slurry may be degassed to reduce porosity for use in such applications as a DPC filler. In a further example, the slurry was degassed under vacuum for 5 minutes prior to being poured.

### Example 2: CaAl₄O₇ with (NaPO₃)₆ and (NaPO₃)₃

260 g CaAl₄O₇ was mixed with a solution containing 51.0 g (NaPO₃)₆ (sodium hexametaphosphate) and 51.0 g (NaPO₃)₃ (sodium trimetaphosphate) in 200 g H₂O. This slurry was degassed under vacuum for 5 minutes, then poured into a 2″×5″ steel tube stoppered at 1 end. After 8 hr, it was placed in an oven at 85° C., which was then heated to 150° C. at 5° C./hr, then held at 150° C. for 1 hr. After cooling, the monolith was removed and heated at 250° C. for 12 hr. The partial substitution of (NaPO₃)₃ for (NaPO₃)₆ produced a cement with a shorter set time and lower shrinkage than that in Example 1.

### Example 3: CaAl₄O₇ with (NaPO₃)₆ and H₃PO₄

260 g CaAl₄O₇ was mixed with a solution containing 51.0 g (NaPO₃)₆ (sodium hexametaphosphate) and 57.5 g 85% H₃PO₄ in 99 g H₂O. This slurry was degassed under vacuum for 5 minutes, then poured into a thin-walled cylindrical Al vessel approximately 2.0″ OD×5″ tall. This became warm and had set after 30 minutes. After 8 hr, it was placed in an oven at 85° C., which was then ramped to 150° C. at 5° C./hr, then held at 150° C. for 1 hr. After cooling, the Al vessel was removed (see FIG. 2).

### Example 4: CaAl₄O₇ with (NH₄PO₃)ₓ and NH₄H₂PO₄

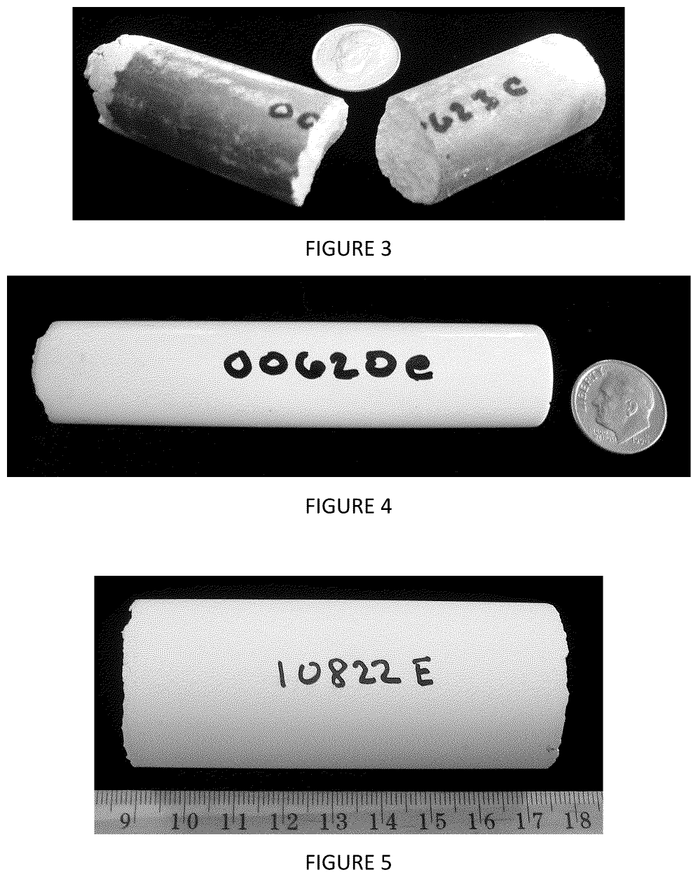

23.7 g CaAl₄O₇ and 18.8 g 10-34-0 (a fertilizer comprising ammonium polyphosphate with some orthophosphate) were mixed and allowed to set in a glass tube. This was placed in an oven at 85° C., which was then ramped to 150° C. at 5° C./hr. it was then placed in a 250° C. oven for 12 hr. After cooling, the glass tube was removed by breaking (see FIG. 3).

### Example 5: CaAl₄O₇ with H₃PO₄ and 10-34-0

26 g CaAl₄O₇, 6.9 g H₃PO₄, 12.5 g 10-34-0, and 2.0 g H₂O were mixed and poured into a glass tube. The mixture got warm and set within 0.5 hr. This was placed in an oven at 85° C., which was then ramped to 150° C. at 5° C./hr. It was then placed in a 250° C. oven for 12 hr. After cooling, the glass tube was removed by breaking (see FIG. 4).

### Example 6: CaAl₄O₇ and Al₂O₃ with H₃PO₄ and NaH₂PO₄

137.7 g Al₂O₃ (corundum) and 15.3 g CaAl₄O₇ were dry blended, then mixed with a solution of 11.5 g 85% H₃PO₄ and 24.0 g NaH₂PO₄ in 37.8 g H₂O. The slurry was blended smooth and poured into a glass tube, then heated from at 85° C. to 150° C. at 5° C./hr. The tube was then placed in a 250° C. oven for 12 hr. After cooling, the cured cement monolith was removed from the tube (see FIG. 5).

### Example 7: CaAl₁₂O₁₉ and CaAl₄O₇ with H₃PO₄ and NaH₂PO₄

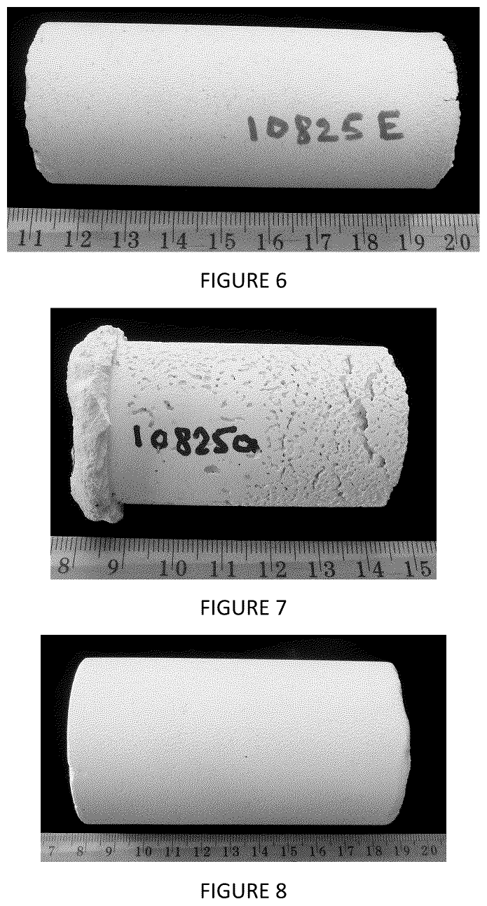

100.2 g of a mixture of approximately 5 wt % CaAl₄O₇ and 95 wt % CaAl₁₂O₁₉ was combined with a solution of 25.9 g H₃PO₄ and 27.0 g NaH₂PO₄ in 33.3 g H₂O. This was blended smooth and poured into a glass tube, then heated from at 85° C. to 150° C. at 5° C./hr. The tube was then placed in a 250° C. oven for 12 hr. After cooling, the cured cement monolith was removed from the tube (see FIG. 6).

### Example 8: CaAl₁₂O₁₉ and Al₂O₃ with H₃PO₄ and (NaPO₃)₆

100.2 g of a mixture of approximately 10 wt % Al₂O₃ and 90 wt % CaAl₁₂O₁₉ was combined with a solution of 25.9 g H₃PO₄ and 22.9 g (NaPO₃)₆ in 39.6 g H₂O. This was blended smooth, evacuated, poured into a glass tube, then heated from at 85° C. to 150° C. at 5° C./hr. The tube was then placed in a 250° C. oven for 12 hr. After cooling, the cured cement monolith was removed from the tube (see FIG. 7).

### Example 9: CaAl₂O₄ and CaAl₄O₇ with (NaPO₃)₆

74.9 g CaAl₄O₇: was dry blended with 11.5 g CaAl₂O₄. This mixture was then combined with a solution containing 36.7 g (NaPO₃)₆ in 43.2 g H₂O and mixed with a spatula. The slurry was evacuated and poured into a 1.25″×5″ glass mold stoppered at one end. This was heated from 85° to 150° C. at 5° C./hr, then held at 150° C. for 1 hr. The resulting cement monolith was removed from the tube and heated at 250° C. for 12 hr.

### Example 10: CaSiO₃ and CaAl₄O₇ 24:1 with (NaPO₃)₆

345.6 g CaSiO₃ and 31.2 g CaAl₄O₇ (a 24:1 ratio mol/mol) were dry blended, then combined with a solution of 163.2 g (NaPO₃)₆ in 192 g H₂O and mixed with a spatula. The slurry was evacuated and poured into a 2″×5″ steel mold stoppered at one end. This was heated from 85° to 150° C. at 5° C./hr, then held at 150° C. for 1 hr.

### Example 11: CaSiO₃ and CaAl₄O₇ 1:1 with (NaPO₃)₆

120 g CaSiO₃ and 260 g CaAl₄O₇ (a 1:1 ratio mol/mol) were dry blended, then combined with a solution of 142.8 g (NaPO₃)₆ in 198 g H₂O and mixed with a spatula. The slurry was evacuated and poured into a 2″×5″ steel mold stoppered at one end. This was heated from 85° to 150° C. at 5° C./hr, then held at 150° C. for 1 hr.

### Example 12: CaSiO₃ and CaAl₄O₇ 1:9 with (NaPO₃)₆

19.2 g CaSiO₃ and 374.4 g CaAl₄O₇ (a 1:9 ratio mol/mol) were dry blended, then combined with a solution of 153.0 g (NaPO₃)₆ in 180 g H₂O and mixed with a spatula. The slurry was evacuated and poured into a 2″×5″ steel mold stoppered at one end. This was heated from 85° to 150° C. at 5° C./hr, then held at 150° C. for 1 hr.

### Example 13: CaAl₄O₇ and GdAlO₃ with (NaPO₃)₆

172.9 g CaAl₄O₇ and 9.0 g GdAlO₃ were dry blended, then combined with a solution of 71.4 g (NaPO₃)₆ in 90 g H₂O and mixed with a spatula. The slurry was evacuated and poured into two 1.25″×4.5″ glass molds, each stoppered at one end. These were heated from 85° to 150° C. at 5° C./hr, then held at 150° C. for 1 hr. Adding GdAlO₃ reduced the shrinkage of the cement upon cure. Gd also acts as a neutron absorber.

### Example 14: CaAl₄O₇ and Gd₂O₃ with (NaPO₃)₆

91 g CaAl₄O₇ and 4.0 g Gd₂O₃ were dry blended, then combined with a solution of 35.7 g (NaPO₃)₆ in 45 g H₂O and mixed with a spatula. The slurry was evacuated and poured into a 1.25″×4.5″ glass mold stoppered at one end. This was heated from 85° to 150° C. at 5° C./hr, then held at 150° C. for 1 hr. Adding Gd₂O₃ reduced the shrinkage of the cement upon cure, and also shortened set time. Gd also acts as a neutron absorber.

### Example 15: CaSiO₃ with Al(OH)₃

360 g CaSiO₃ (Vansil w-20) was dry blended with 23.4 g Al(OH)₃. This was then combined with 250 g H₂O. To this slurry was added 140.0 g BPO₄ powder, which was mixed in with a spatula. The slurry was evacuated and poured into a 2″×5″ steel mold stoppered at one end. This was heated from 85° to 150° C. at 5° C./hr, then held at 150° C. for 1 hr. The resulting cement monolith was removed from the tube and heated at 250° C. for 12 hr (see FIG. 8).

### Example 16: Granite with H₃PO₄

0.50 kg of weathered granite was milled to pass an ASTM 200 mesh sieve. This was mixed with a solution containing 115 g 85% H₃PO₄ in 250 g H₂O. This slurry was evacuated and poured into a 12 oz Al beer can, which was heated from 85° to 150° C. at 5° C./hr, then held at 150° C. for 1 hr. The beer can was then peeled off to reveal a cement monolith.

### Example 17: Glass with H₃PO₄

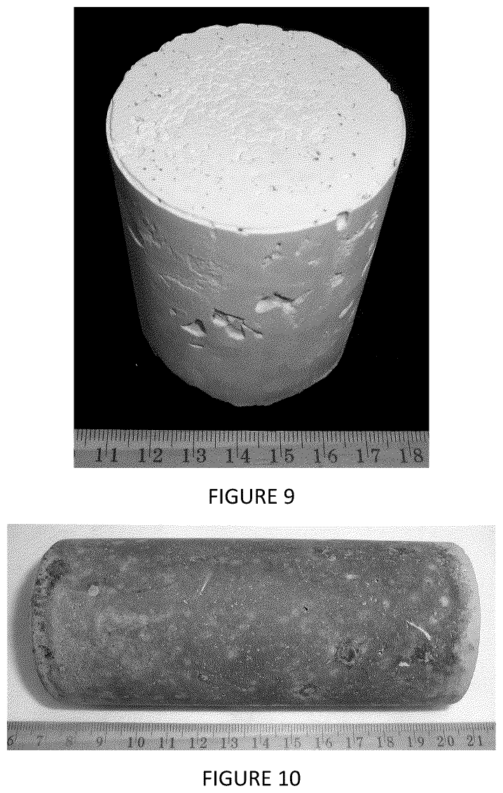

266.5 g glass flour from a wine bottle that was ground to pass a 200 mesh ASTM sieve was blended with a solution of 57.5 g 85% H₃PO₄ in 99 g H₂O. This slurry was degassed under vacuum and poured into a stainless steel tube 2.1″ID×5″ tall fitted with a stopper at one end. The tube was heated from at 85° C. to 150° C. at 5° C./hr, then held at 150° C. for 1 hr. The resulting cement monolith was removed from the tube and heated at 250° C. for 12 hr (see FIG. 9).

### Example 18: Fly Ash with (NaPO₃)₆

0.50 kg of coal fly ash (from Evergy in Kansas) was mixed with a solution of 102 g (NaPO₃)₆ in 135 g H₂O. This slurry was degassed under vacuum and poured into an Al Red Bull can, which was heated from at 85° C. to 150° C. at 5° C./hr, then held at 150° C. for 1 hr. The can was then peeled off to reveal a cement monolith (see FIG. 10).

### Sample 20824e: Grossite-Wollastonite Cement.

In this formulation, grossite is the primary component with wollastonite as an additive. Here, 374.4 g CaAl4O7 and 19.2 g CaSiO3 (Vansil w-10) were dry blended and sieved 6 times. Next, 153.0 g SHMP was dissolved in 180.0 g H2O; this was mixed with the CaSiO3 ?CaAl4O7 mixture to form a smooth slurry. The slurry was then degassed under vacuum for 5 minutes, remixed, and poured into 4 50 mL centrifuge tubes. The slurry filled tubes were heated from 85 to 130° C. at 5° C./hr and held at 130° C. for 8 hr. After cooling, the resulting monoliths were removed from the tubes, heated from 130 to 180° C. at 5° C./hr, cooled, and heated at 250° C. for 12 hr.

Mechanical test data on sample 20824b obtained post-irradiation and post-hydrothermal testing produced interesting results. They indicate that this grossite-wollastonite cement has a significant compressive strength and is higher than most of the cements tested over the last two years on this project. The apparent increase in strength after irradiation and hydrothermal exposure coupled with the observation of substantial chemical alteration of the cement to boehmite and hydroxylapatite post-hydrothermal exposure is remarkable.

### Further Example

C3A-NaH₂PO₄ Cement

120 g NaH₂PO₄ is dissolved in 180 g H₂O. This solution is cooled to −10° C. and mixed with 222 g Ca₃Al₂O₆ (C3A) previously cooled to −10° C. or lower temperature.

### Sample 20830a: Grossite Cement.

260.0 g CaAl4O7 was mixed with a solution containing 51.0 g each (NaPO3)3 (Thermo Alfa, CAS 7785-84-4) in 126.0 g H2O. The resulting slurry was blended until smooth, then degassed under vacuum for 5 minutes, remixed, and poured into 4 50 mL centrifuge tubes. These were heated from 85 to 130° C. at 5° C./hr and held at 130° C. for 8 hr. After cooling, the resulting monoliths were removed from the tubes, heated from 130 to 180° C. at 5° C./hr, cooled, and heated at 250° C. for 12 hr.

Mechanical test data on grossite cement sample 20830a obtained baseline, post-irradiation and post-hydrothermal testing produced impressive results. They indicate that this grossite cement formulation has a significant compressive strength and is again higher than most of the cements tested over the last two years on this project. The apparent and significant decrease in strength after irradiation and hydrothermal exposure coupled with the observation of substantial chemical alteration of the cement to AlOOH and hydroxylapatite post-hydrothermal exposure is remarkable.

### Mechanical Test Data for Sample 20830e.

UCC Strength (MPa): 53-69; Static Young's Modulus (GPa): 13-27; Static Poisson's Ratio: 0.18 to 0.24.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents and publications cited above are hereby incorporated by reference.

In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A composition, comprising:
a source of calcium that is calcium aluminate and a source of phosphate that cures to form a calcium aluminate phosphate cement (CAPC), wherein phosphate in the phosphate binder is provided by a phosphate source.

2. The composition of claim 1, wherein the calcium aluminate is selected from the group consisting of CaAl₄O₇, CaAl₁₁O₁₉ and CaAl₂O₄.

3. The composition of claim 1, wherein the phosphate source is selected from the group consisting of calcium phosphate.

4. The composition of claim 1, wherein the mole ratio of calcium aluminate to total phosphate is between 0.5 and 10.

5. The composition of claim 1, wherein the mole ratio of calcium aluminate to total phosphate is between 1 and 2.

6. The composition of claim 1, wherein the phosphate source is selected from the group consisting of alkali orthophosphates, metaphosphates and polyphosphates.

7. The composition of claim 4, wherein the phosphate source is a metaphosphate and the metaphosphate is selected from the group consisting of HPO₃, NaPO₃, KPO₃ and NH₄PO₃.

8. The composition of claim 4, wherein the phosphate source is an alkali orthophosphate selected from the group consisting of NaH₂PO₄, Na₂HPO₄, Na₃PO₄, KH₂PO₄, K₂HPO₄, K₃PO₄, NH₄H₂PO₄ and (NH₄)₂HPO₄.

9. The composition of claim 1, wherein the phosphate source is orthophosphoric acid also known as phosphoric acid H₃PO₄.

10. The composition of claim 1, wherein the phosphate source is selected from the group consisting of alkali phosphates and polyphosphates.

11. The composition of claim 10, wherein the polyphosphate is selected from the group consisting of (NaPO₃)₆, Na₅P₃O₁₀, (NaPO₃)₃, and their potassium or ammonium derivatives.

12. The composition of claim 3, wherein the calcium phosphate is Ca(H₂PO₄)₂.

13. The composition of claim 1, wherein the phosphate source is Na₅P₃O₁₀.

14. The composition of claim 1, wherein the phosphate source is a waste product comprising a phosphate.

15. The composition of claim 1, wherein the calcium aluminate is combined with one or more other calcium compounds chosen from the group consisting of calcium silicate, calcium borate, calcium borosilicate, calcium aluminum silicate, and calcium aluminum borate.

16. An article, comprising:
a body comprising the composition of claim 1.

17. A method of making a cement, comprising:
mixing a source of calcium that is a calcium aluminate with a solution comprising water and a phosphate source to form a slurry;
forming the slurry into a pre-article; and
curing the pre-article into an article to form a cementaceous body.

18. The method of claim 17, wherein the pre-article is cured at a temperature between ambient and 250° C.

19. The method of claim 17, wherein the pre-article is cured at a temperature between 15° C. and 250° C.

20. The method of claim 17, wherein the calcium aluminate is selected from the group consisting of CaAl₄O₇, CaAl₁₁O₁₉ and CaAl₂O₄.

21. The method of claim 17, wherein the phosphate source is selected from the group consisting of calcium phosphate.

22. The method of claim 17, wherein the mole ratio of calcium aluminate to total phosphate is between 0.5 and 10.

23. The method of claim 17, wherein the mole ratio of calcium aluminate to total phosphate is between 1 and 2.
